(19) United States
(12) Patent Application Publication
(10) Pub. No.: US 2025/0141367 A1
(43) Pub. Date: May 1, 2025

(54) ELECTRICAL POWER CONVERTER

(71) Applicant: DENSO CORPORATION, Kariya-city (JP)

(72) Inventors: Yosuke SUZUKI, Kariya-city (JP); Masahiro Kusumoto, Kariya-city (JP)

(73) Assignee: DENSO CORPORATION, Kariya-city (JP)

(21) Appl. No.: 19/004,598

(22) Filed: Dec. 30, 2024

Related U.S. Application Data
(63) Continuation of application No. PCT/JP2023/021308, filed on Jun. 8, 2023.

(30) Foreign Application Priority Data
Jul. 8, 2022 (JP) 2022-110235

(51) Int. Cl. H02M 7/487; B60L 50/51; B60L 50/60; B60L 53/24; H02M 7/5387; H02M 7/5395

(52) U.S. Cl. CPC H02M 7/487; B60L 50/51; B60L 50/60; B60L 53/24; H02M 7/5387; H02M 7/5395; B60L 2210/40

(57) ABSTRACT

An electrical power converter includes a three-level inverter and a rotating electrical machine which includes windings. The three-level inverter includes first and second electrical storage devices, and switches. A positive side of the first electrical storage device is connected to a positive terminal of the storage battery. A negative side of the second electrical storage device is connected to a negative terminal of the storage battery. The electrical power converter also includes a connector and a controller. The connector achieves electrical connection of the electrical device with the three-level inverter and also achieves electrical connection of the electrical device with the storage battery through the neutral point. The controller works to control switching operations of the switches to achieve transmission of electrical power between the electrical device and the storage battery with the three-level inverter and the electrical device connected together through the connector.

### CROSS REFERENCE TO RELATED DOCUMENT

The present application claims the benefit of priority of Japanese Patent Application No. 2022-110235 filed on Jul. 8, 2022, the disclosure of which is incorporated in its entirety herein by reference.

### TECHNICAL FIELD

This disclosure relates generally to a power converter including a three-level inverter and a rotating electrical machine equipped with windings electrically connected to a three-level inverter.

### BACKGROUND ART

Japanese patent No. 6347453 teaches a power converter which is used with a charging control system working to use an external charger to electrically charge a storage battery installed in an electrical vehicle. The charging control system uses a three-level inverter serving as a power converter for reducing the leakage of electrical current.

### PRIOR ART DOCUMENT

### Patent Literature

FIRST PATENT LITERATURE: Japanese Patent No. 6347453

### SUMMARY OF THE INVENTION

Power converters may be employed in systems equipped with a storage battery and an electrical device electrically connected to the storage battery. For instance, when the storage battery is installed in a vehicle, such as an electrical vehicle, it requires the storage battery to have a high capacity. In such a case, a high voltage developed at a terminal of the storage battery will result in a variety of requirements for the system to actuate the electrical device. The power converter, therefore, needs to have an additional structure in order to meet the requirements, which may lead to an undesirable increase in size of the power converter.

This disclosure is made in view of the above drawback. It is a principal object of this disclosure to provide a power converter capable of having a decreased size.

According to one aspect of this disclosure, there is provided an electrical power converter for use with a system including a storage battery and an electrical device which is electrically connectable with the storage battery. The electrical power converter comprises: (a) a three-level inverter which is electrically connected to the storage battery; (b) a rotating electrical machine which includes multi-phase windings electrically connected to the three-level inverter; (c) a connector; and (d) a controller. The electrical device is disposed outside the electrical power converter and implemented by a charger working to charge the storage battery. The three-level inverter includes a first electrical storage device, a second electrical storage device, and switches. The first electrical storage device and the second electrical storage device are connected in series with each other. The switches work to connect the windings with a positive side of the first electrical storage device, a neutral point between a negative side of the first electrical storage device and a positive side of the second electrical storage device, or a negative side of the second electrical storage device. The switches include upper arm switches and lower arm switches for a plurality of phases of the rotating electrical machine. The upper and lower arm switches being connected in series with each other. The switches of the three-level inverter also include clamp switches each for one of the phases of the rotating electrical machine. Each of the clamp switches establishes or blocks a flow of electrical current between a corresponding one of the windings and the neutral point. The positive side of the first electrical storage device is connected to a positive terminal of storage battery. The negative side of the second electrical storage device is connected to a negative terminal of the storage battery. The connector works to achieve electrical connection of the electrical device with the three-level inverter and also achieve electrical connection of the electrical device with the storage battery through the neutral point. The controller works to control switching operations of the switches to achieve transmission of electrical power between the electrical device and the storage battery with the three-level inverter and the electrical device connected together through the connector. The connector includes a neutral point connector and a negative connector. The neutral point connector connects a positive terminal of the charger to the neutral point. The negative connector connects a negative terminal of the charger to the negative side of the second electrical storage device. The controller works to start a voltage step-up task to perform the switching operations with the charger connected to the three-level inverter through the neutral point connector and the negative connector to create flows of electrical current through the three-level inverter and the windings, thereby stepping-up charging voltage developed at the charger and delivering the stepped-up charging voltage to the storage battery. In the voltage step-up task, the controller turns off a first clamp switch that is at least one of the clamp switches for a specified phase that is at least one of the phases of the multi-phase rotating electrical machine and alternately turns on first upper and lower arm switches that are the upper and lower arm switches for the specified phase. The controller also turns off second upper and lower arm switches that are the upper and lower arm switches other than the first upper and lower arm switches and turns on a second clamp switch that is at least one of the clamp switches other than the first clamp switch.

The connector in the above structure, as described above, achieves electrical connection of the electrical device with the three-level inverter and also achieves electrical connection of the electrical device with the storage battery through the neutral point. The switching operations of the switches are performed with the electrical device and the three-level inverter connected together through the neutral point, thereby meeting requirements for the system without needing to have an additional circuit in the electrical power converter, which enables the electrical power converter to be reduced in size thereof.

According to another aspect of this disclosure, there is provided an electrical power converter for use with a system including a storage battery and an electrical device which is electrically connectable with the storage battery. The electrical power converter comprises: (a) a three-level inverter which is electrically connected to the storage battery; (b) a rotating electrical machine which includes windings electrically connected to the three-level inverter; (c) a connector; and (d) a controller. The electrical device is disposed outside the electrical power converter and implemented by a low-voltage charger working to charge the storage battery. The low-voltage charger has a charging voltage lower than a voltage rating of the storage battery. The three-level inverter includes a first electrical storage device, a second electrical storage device, and switches. The first electrical storage device and the second electrical storage device are connected in series with each other. The switches work to connect the windings with a positive side of the first electrical storage device, a neutral point between a negative side of the first electrical storage device and a positive side of the second electrical storage device, or a negative side of the second electrical storage device. The positive side of the first electrical storage device is connected to a positive terminal of storage battery. The negative side of the second electrical storage device is connected to a negative terminal of the storage battery. The connector works to achieve electrical connection of the electrical device with the three-level inverter and also achieve electrical connection of the electrical device with the storage battery through the neutral point. The controller works to control switching operations of the switches to achieve transmission of electrical power between the electrical device and the storage battery with the three-level inverter and the electrical device connected together through the connector. The connector includes a neutral point connector, a negative connector, and a positive connector. The neutral point connector connects a positive terminal of the low-voltage charger to the neutral point. The negative connector connects a negative terminal of the low-voltage charger to the negative side of the second electrical storage device. The positive connector connects a positive side of a high-voltage charger whose charging voltage is lower than that of the low-voltage charger with a positive side of the first electrical storage device. The controller works to start a voltage step-up task to perform the switching operations with the low-voltage charger connected to the three-level inverter through the neutral point connector and the negative connector to create flows of electrical current through the three-level inverter and the windings, thereby stepping-up charging voltage developed at the low-voltage charger and delivering the stepped-up charging voltage to the storage battery.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a structural view which shows a motor control system according to the first embodiment;

FIG. 2 is a circuit diagram which illustrates layout of connections to a high-voltage charger;

FIG. 3 is a circuit diagram which demonstrates an example of a voltage step-up task;

FIG. 4 is a circuit diagram which demonstrates an example of a voltage step-up task;

FIG. 5 is a block diagram which illustrates operations of a voltage step-up task;

FIG. 6 is a structural view which illustrates a motor control system according to the second embodiment;

FIG. 7 is a circuit diagram which demonstrates an example of a voltage step-up task in the second embodiment;

FIG. 8 is a circuit diagram which demonstrates an example of a voltage step-up task in the second embodiment; and

FIG. 9 is a structural view which illustrates a motor control system according to another embodiment.

### MODE FOR CARRYING OUT THE INVENTION

### First Embodiment

An electrical power converter according to the first embodiment will be described below with reference to the drawings. The electrical power converter is mounted in a vehicle, such as an electrical vehicle.

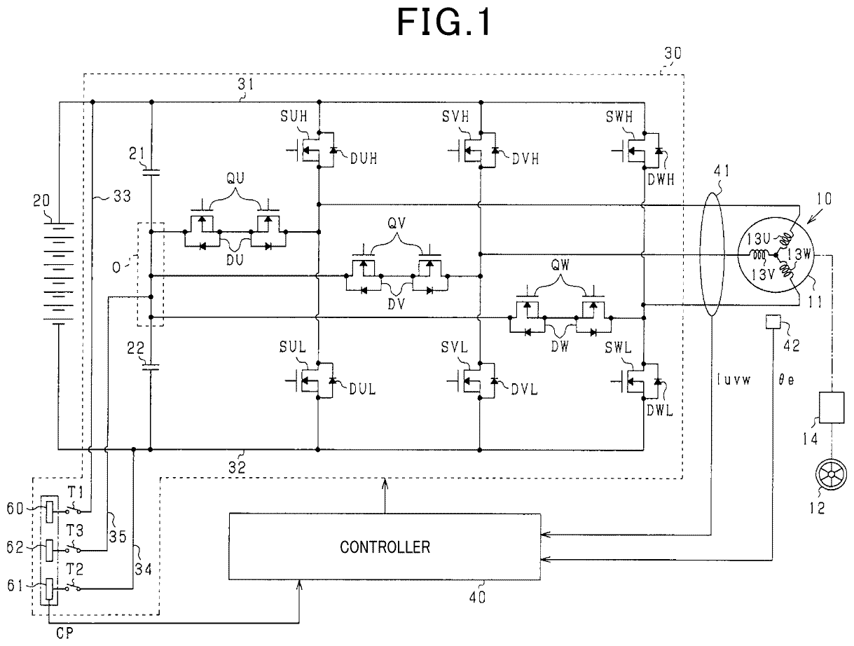

FIG. 1 illustrates a motor control system which is mounted in the vehicle and includes the rotating electrical machine 10, the storage battery 20, the inverter 30, and the controller 40. The rotating electrical machine 10 works as a main power source installed in the vehicle and has the rotor 11 which transmits torque to the drive wheels 12. The rotating electrical machine 10 is made of a three-phase synchronous motor which has the U-phase winding 13U, the V-phase winding 13V, and the W-phase winding 13W which are star-connected together in the form of a stator winding. The U-phase, V-phase, and W-phase windings 13U, 13V, and 13W are shifted by an electrical angle of 120° from each other. The rotating electrical machine 10 may be designed as a permanent magnet synchronous machine. In this embodiment, the rotating electrical machine 10 and the inverter 30 function as an electrical power converter.

A rotating shaft of the rotor 11 and an axle of the drive wheels 12 are mechanically connected together through the power transmission device 14 (also called a power train) Specifically, the power transmission device 14 includes at least one of a clutch and a gearbox or transmission. The clutch has an input shaft and an output shaft and works to connect or disconnect them. The clutch also works to control a degree to which torque is transmitted from the rotor 11 to the axle of the drive wheels 12. The clutch is made of, for example, a hydraulically-powered wet clutch. The transmission works to control a gear ratio that is a speed ratio of an input shaft and an output shaft of the transmission. The transmission is made of, for example, a CVT (Continuously variable transmission) or a multi-speed gear transmission.

The storage battery 20 is electrically connected to the rotating electrical machine 10 through the inverter 30. The storage battery 20 is made of an assembled battery consisting of electrical cells electrically connected in series with each other. Each of the electrical cells is implemented by a secondary cell, such as a lithium-ion cell. The storage battery has a terminal-to-terminal voltage VH of, for example, 600V to 800V.

The inverter 30 works as a power converting device which converts DC (i.e., direct-current) power delivered from the storage battery 20 into three-phase AC (i.e., alternating-current) power in a switching control operation and supplies it to the rotating electrical machine 10. The inverter 30 includes the first capacitor 21 serving as a first electrical storage device and the second capacitor 22 serving as a second electrical storage device. The first and second capacitors 21 and 22 are connected to the storage battery 20. The first capacitor 21 and the second capacitor 22 are connected in series with each other. The series-connected assembly of the first and second capacitors 21 and 22 is electrically connected in parallel to the storage battery 20. The first capacitor 21 has an electrostatic capacitance which is equal to that of the second capacitor 22. The first capacitor 21 and the second capacitor 22 may be arranged outside or inside the inverter 30.

The inverter 30 in this embodiment is implemented by a T-type three-level inverter which includes three switch assemblies: a U-phase series-connected assembly of an upper arm switch SUH and a lower arm switch SUL, a V-phase series-connected assembly of an upper arm switch SVH and a lower arm switch SVL, and a W-phase series-connected assembly of an upper arm switch SWH and a lower arm switch SWL. Each of the upper and lower arm switches SUH to SWL is made of a voltage-controlled semiconductor switching device, such as an n-channel MOSFET. Each of the upper and lower arm switches SUH to SWL has a drain serving as a high-potential terminal and a source serving as a low-potential terminal. The switches SUH, SVH, SWH, SUL, SVL, and SWL are equipped with the body-diodes DUH, DVH, DWH, DUL, DVL, and DWL, respectively.

The U-phase upper arm switch SUH has the source connected to the drain of the U-phase lower arm switch SUL. A joint of the U-phase upper arm switch SUH and the U-phase lower arm switch SUL is connected to a U-phase input terminal of the rotating electrical machine 10. The V-phase upper arm switch SVH has the source connected to the drain of the V-phase lower arm switch SVL. A joint of the V-phase upper arm switch SVH and the V-phase lower arm switch SVL is connected to a V-phase input terminal of the rotating electrical machine 10. The W-phase upper arm switch SWH has the source connected to the drain of the W-phase lower arm switch SWL. A joint of the W-phase upper arm switch SWH and the W-phase lower arm switch SWL is connected to a W-phase input terminal of the rotating electrical machine 10.

The drains of the upper arm switches SUH to SWH are connected together using the positive bus bar 31. The positive bus bar 31 is connected to the positive terminal of the storage battery 20 and the first end of the first capacitor 21. The first capacitor 21 has the second end connected to the first end of the second capacitor 22 through the neutral point O. The sources of the lower arm switches SUL to SWL are connected to the negative bus bar 32. The negative bus bar 32 is connected to the negative terminal of the storage battery and the second end of the second capacitor 22.

The inverter 30 includes the clamp switches QU, QV, and QW each of which works to bidirectionally permit or block the flow of electrical current. Each of the clamp switches QU to QW is implemented by a voltage-controlled semiconductor switching device, i.e., an n-channel MOSFET. The clamp switches QU to QW are equipped with the body diodes DU, DV, and DW, respectively.

Specifically, the U-phase clamp switch QU has switching devices which are connected together at sources thereof. One of the switching devices of the U-phase clamp switch QU has a drain connected to a joint of the U-phase upper arm switch SUH and the U-phase lower arm switch SUL, while the other switching device has a drain connected to the neutral point O. The V-phase clamp switch QV has switching devices which are connected together at sources thereof. One of the switching devices of the V-phase clamp switch QV has a drain connected to a joint of the V-phase upper arm switch SVH and the V-phase lower arm switch SVL, while the other switching device has a drain connected to the neutral point O. Similarly, the W-phase clamp switch QW has switching devices which are connected together at sources thereof. One of the switching devices of the W-phase clamp switch QW has a drain connected to a joint of the W-phase upper arm switch SWH and the W-phase lower arm switch SWL, while the other switching device has a drain connected to the neutral point O.

The motor control system also includes the phase-current sensor 41 and the angular position sensor 42. The phase-current sensor 41 works to measure the phase-current I_{uvw} that is an electrical current flowing through each of the U-phase winding 13U, the V-phase winding 13V, and the W-phase winding 13W of the rotating electrical machine 10. The phase-current sensor 41 may be designed to measure at least two of the currents flowing through the U-phase winding 13U, the V-phase winding 13V, and the W-phase winding 13W as the phase-currents I_{uvw}. The angular position sensor 42 is made of, for example, a resolver which measures an electrical angle de of the rotating electrical machine 10. Outputs of the sensors 41 and 42 are delivered to the controller 40.

The controller 40 executes programs stored in a storage device installed therein to perform various control tasks. The control tasks may be realized by hardware, such as an electronic circuit or a combination of hardware and software.

The controller 40 controls switching operations of the upper and lower arm switches SUH to SWL and the clamp switches QU to QW. Specifically, the controller 40 performs a motor drive control task to feed a controlled variable of the rotating electrical machine 10 back to a command or control signal outputted therefrom. The controlled variable of the motor driver control task is, for example, a degree of torque outputted from the rotating electrical machine 10.

An external charger is arranged outside the vehicle to electrically charge the storage battery 20. The external charger is implemented by a stationary battery charger also called a fast charger.

The inverter 30 is connectable with the external charger. Specifically, the inverter 30 is connectable with the high-voltage charger 50 or the low-voltage charger 51. The charging voltage of the high-voltage charger 50 is substantially equal to a rated voltage of the storage battery 20 and, for example, 600V to 800V. The charging voltage of the low-voltage charger 51 is lower than the rated voltage of the storage battery 20 and may be, for example, 400V. In other words, the storage battery 20 is a high-capacity storage battery capable of being electrically charged up to a voltage higher than the charging voltage of the low-voltage charger 51. In this disclosure, the low-voltage charger 51 will also be referred to as an electrical device.

The inverter 30 also includes the positive connector 60 and the negative connector 61 which serve as power interfaces used to deliver electrical power from the external charger to the storage battery 20. The positive terminal of the storage battery 20 is connected to the positive connector 60 through the positive conductor 33. The positive conductor 33 has the positive switch T1. The negative terminal of the storage battery 20 is connected to the negative connector 61 through the negative conductor 34. The negative conductor 34 has the negative switch T2. The switches T1 and T2 work to selectively permit or block flow of electrical current from the external charger to the storage battery 20. The switches T1 and T2 are made of, for example, mechanical relays or semiconductor switching devices. The controller 40 turns on or off the switches T1 and T2.

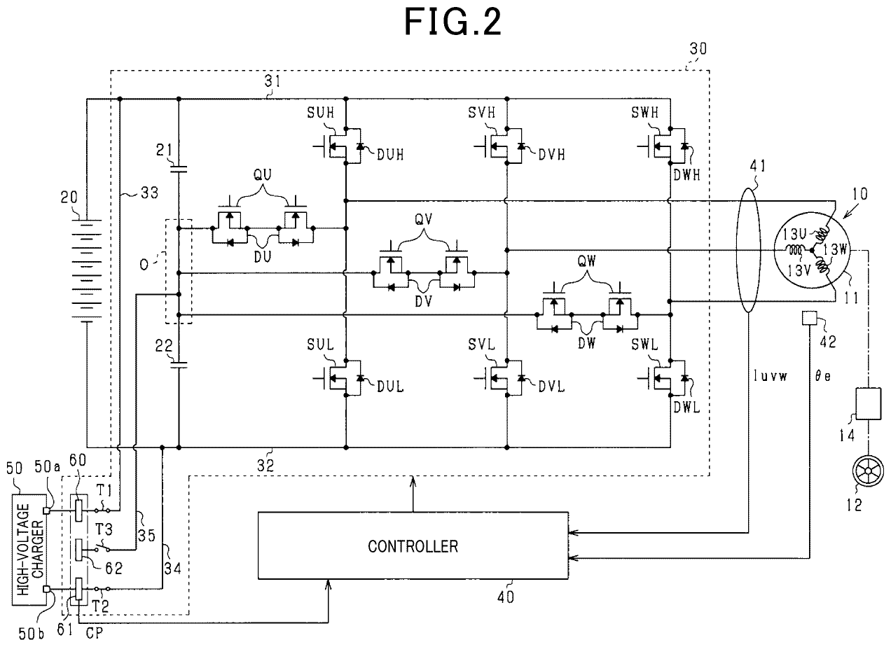

The following discussion will refer to a first charge control operation to electrically charge the storage battery 20 using the high-voltage charger 50. The high-voltage charger 50, as can be seen in FIG. 2, has the positive terminal 50a connected to the positive terminal of the storage battery 20 through the positive connector 60, the positive conductor 33, and the positive switch T1. The high-voltage charger 50 has the negative terminal 50b connected to the negative terminal of the storage battery 20 through the negative connector 61, the negative conductor 34, and the negative switch T2. This achieves electrical connection of the high-voltage charger 50 with the storage battery 20.

Specifically, a user (e.g., a driver) or an operator of the vehicle connects a connecting plug and a high-voltage charging inlet together. The connecting plug is made up of the positive terminal 50a and the negative terminal 50b of the high-voltage charger 50. The high-voltage charging inlet is made up of the positive connector 60 and the negative connector 61. The connection of the connecting plug of the high-voltage charger 50 and the high-voltage charging inlet causes a pilot signal CP to be produced by the high-voltage charger 50 and then inputted to the controller 40 through the high-voltage charging inlet. The pilot signal CP is a signal carrying information about whether the connecting plug of the high-voltage charger 50 and the high-voltage charging inlet have been connected together. The controller 40 analyzes the pilot signal CP and determines whether the connecting plug of the high-voltage charger 50 and the high-voltage charging inlet is connected together or not. When determining that the connecting plug of the high-voltage charger 50 is connected to the high-voltage charging inlet, the controller 40 turns on the positive switch T1 and the negative switch T2. This achieves electrical connection of the high-voltage charger 50 with the storage battery 20, so that the high-voltage charger 50 starts charging the storage battery 20.

Next, a second charge control operation to electrically charge the storage battery 20 using the low-voltage charger 51 instead of the high-voltage charger 50 will be described below. The low-voltage charger 51 is, as described above, the external charger whose charging voltage is lower than the rated voltage of the storage battery 20. The higher rated voltage of the storage battery 20 than the charging voltage of the low-voltage charger 51 requires the need for elevating the charging voltage of the low-voltage charger 51 when electrically charging the storage battery 20. To this end, a step-up circuit may be installed in the electrical power converter to raise the charging voltage of the low-voltage charger 51. This, however, may lead to an increased size of the electrical power converter.

In a comparative example where a connecting path is, unlike this embodiment, provided to electrically connect a neutral point of star-connected multi-phase windings to a low-voltage charger, an electrical current may be delivered from the low-voltage charger to a storage battery through the phase-windings, the inverter, and the connecting path. This structure enables the rotating electrical machine and the inverter to serve as a step-up circuit to raise the charging voltage created at the low-voltage charger. Such a structure, however, requires the need for a component(s) to connect the neutral point of the phase windings and the low-voltage charger together, thus resulting in an increase in production cost of the electrical power converter.

In order to alleviate the above drawback, the inverter 30 is, as illustrated in FIG. 1, equipped with the neutral point connector 62 serving as an electrical power interface used to deliver electrical power from the low-voltage charger 51 to the storage battery 20. The neutral point O electrically leads to the neutral point connector 62 through the neutral point conducting wire 35. The neutral point conducting wire 35 has the neutral point switch T3 installed therein. The neutral point switch T3 is a switch which selectively permits or blocks the flow of electrical current from the low-voltage charger 51 to the neutral point O. The neutral point switch T3 is made of, for example, a mechanical relay or a semiconductor switching device. The neutral point switch T3 is turned on or off by the controller 40.

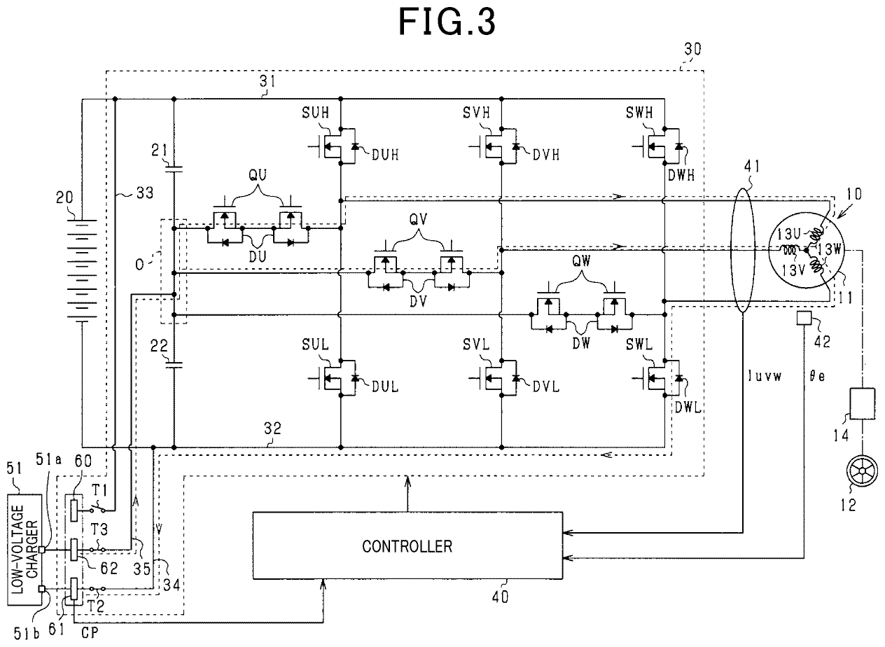

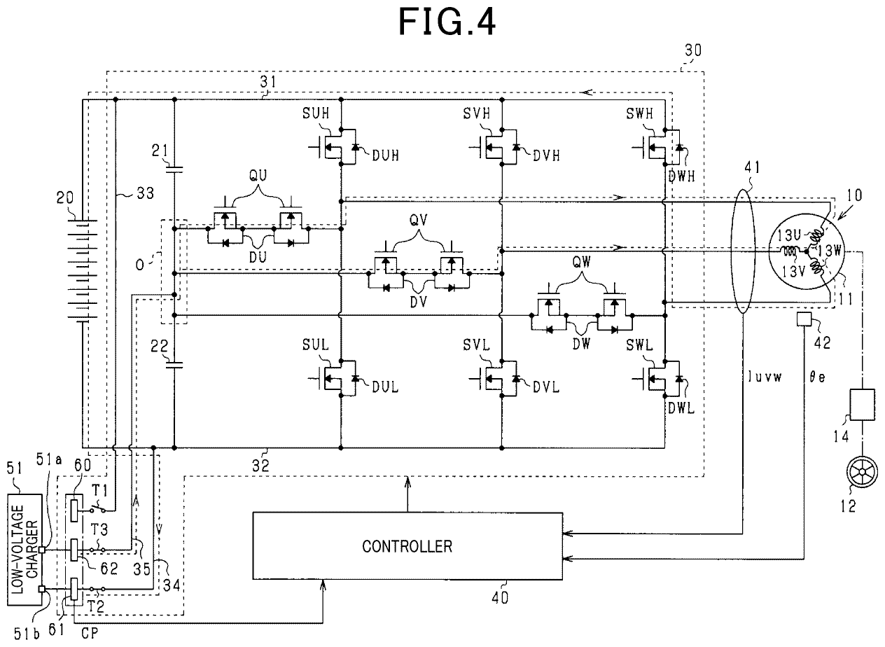

The low-voltage charger 51, as illustrated in FIGS. 3 and 4, has the positive terminal 51a connected to the neutral point O through the neutral point connector 62, the neutral point conducting wire 35, and the neutral point switch T3. The low-voltage charger 51 also has the negative terminal 51b connected to the negative terminal of the storage battery 20 through the negative connector 61, the negative conductor 34, and the negative switch T2. This achieves electrical connection of the low-voltage charger 51 with the storage battery 20 through the neutral point O.

Specifically, the user or operator of the vehicle connects the connecting plug including the positive terminal 51a and the negative terminal 51b of the low-voltage charger 51 with a low-voltage charging inlet including the negative connector 61 and the neutral point connector 62. The connection between the connecting plug of the low-voltage charger 51 and the low-voltage charging inlet causes the pilot signal CP to be produced by the low-voltage charger 51 and then inputted to the controller 40 through the low-voltage charging inlet. The pilot signal CP is a signal carrying information about whether the connecting plug of the low-voltage charger 51 has been connected to the low-voltage charging inlet. The controller analyzes the pilot signal CP and determines whether the connecting plug of the low-voltage charger 51 is connected to the low-voltage charging inlet. When determining that the connecting plug of the high-voltage charger 51 has been 10) connected to the low-voltage charging inlet, the controller 40 turns on the negative switch T2 and the neutral point switch T3. This achieves electrical connection of the low-voltage charger 51 with the storage battery 20 through the neutral point O.

When the inverter 30 is connected to the low-voltage charger 51 through the negative connector 61 and the neutral point connector 62, the controller 40 performs a voltage step-up task to deliver the flow of electrical current to the rotating electrical machine 10 and the inverter 30 to step-up the charging voltage created at the low-voltage charger 51 and supply the stepped-up voltage to the storage battery 20. The voltage step-up task will be described below in detail.

In the voltage step-up task, the controller 40 turns off a specified clamp switch(s) (which will also be referred to below as a first clamp switch(s)) that is one(s) of the U-phase, V-phase, and W-phase clamp switches QU, QV, and QW and alternately turns on a corresponding one of the upper arm switches SUH to SWH (which will also be referred to below as a first upper arm switch) and a corresponding one (which will also be referred to below as a first lower arm switch) of the lower arm switches SUL to SWL which are identical in phase with the first clamp switch. The controller 40 also turns off the rest of the upper and lower arm switches SUH to SWH and SUL to SWL (which will also be referred to below as second upper and lower arm switches) that are other than the first upper and lower switches and turns on the rest of the U-phase, V-phase, and W-phase clamp switches QU, QV, and QW (which will also be referred to below as second clamp switches). FIGS. 3 and 4 demonstrate electrical current flow paths in the voltage step-up task when the phase of the specified clamp switch is the U-phase, that is, the first clamp switch is the U-phase clamp switch QU.

Specifically, when the phase of the first clamp switch (which will also be referred to below as a specified phase) is selected to be the W-phase during execution of the voltage step-up task, the controller 40 turns off the U-phase and V-phase upper and lower arm switches SUH, SVH, SUL, and SVL and the W-phase clamp switch QW and also turns on the U-phase and V-phase clamp switches QU and QV. The controller 40 also turns on the W-phase upper and lower arm switches SWH, and SWL alternately.

FIG. 3 demonstrates electrical current flow paths when the W-phase upper arm switch SWH is turned off, while the W-phase lower arm switch SWL is turned off. This creates a closed circuit consisting of the low-voltage charger 51, the neutral point connector 62, the neutral point switch T3, the U-phase and W-phase clamp switches QU and QV, the U-phase, V-phase, and W-phase windings 13U, 13V, and 13W, the W-phase lower arm switch SWL, the negative bus bar 32, the negative switch T2, and the negative connector 61. This causes magnetic energy to be accumulated in the U-phase, V-phase, and W-phase windings 13U, 13V, and 13W.

FIG. 4 demonstrates electrical current flow paths when the W-phase upper arm switch SWH is turned on, while the W-phase lower arm switch SWL is turned off. This creates a closed circuit consisting of the low-voltage charger 51, the neutral point connector 62, the neutral point switch T3, the U-phase and W-phase clamp switches QU and QV, the U-phase, V-phase, and W-phase windings 13U, 13V, and 13W, the W-phase upper arm switch SWH, the positive bus bar 31, the storage battery 20, the negative switch T2, and the negative connector 61. This causes the charging voltage produced by the low-voltage charger 51 to be stepped-up and then supplied to the storage battery 20.

The specified phase may be other than the W-phase. When the specified phase is selected to be the U-phase, the controller 40 turns off the V-phase and W-phase upper and lower arm switches SVH, SWH, SVL, and SWL and the U-phase clamp switch QU, turns on the V-phase and W-phase clamp switches QV and QW, and also turns on the U-phase upper and lower arm switches SUH and SUL alternately. When the specified phase is selected to be the V-phase, the controller 40 turns off the U-phase and W-phase upper and lower arm switches SUH, SWH, SUL, and SWL and the V-phase clamp switch QV, turns on the U-phase and W-phase clamp switches QU and QW, and also turns on the V-phase upper and lower arm switches SVH, and SVL alternately.

When the specified phase includes both the U-phase and the V-phase, the controller 40 turns off the W-phase upper and lower arm switches SWH and SWL and the V-phase clamp switches QU and QV, turns on the W-phase clamp switch QW, and also turns on the U-phase and V-phase upper and lower arm switches SUH, SVH, SUL, and SVL alternately. When the specified phase is selected to include the V-phase and the W-phase, the controller 40 turns off the U-phase upper and lower arm switches SUH, and SUL, and the V-phase and W-phase clamp switches QV and QW, turns on the U-phase clamp switch QU, and also turns on the V-phase and W-phase upper and lower arm switches SVH, SWH, SVL, and SWL alternately. When the specified phase is selected to include the U-phase and the W-phase, the controller 40 turns off the V-phase upper and lower arm switches SVH, and SVL, and the U-phase and W-phase clamp switches QU, and QW, turns on the V-phase clamp switch QV, and also turns on the U-phase and W-phase upper and lower arm switches SUH, SWH, SUL, and SWL alternately.

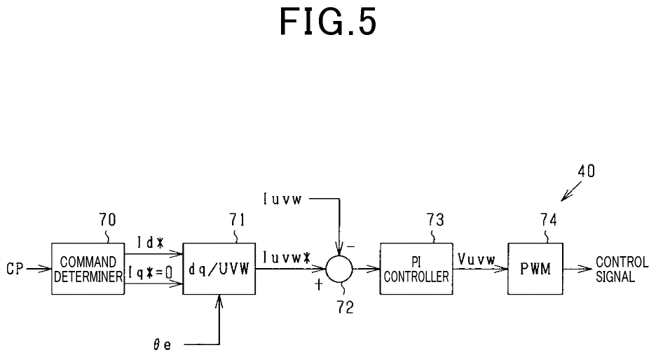

In the voltage step-up task, the controller 40 provides flows of electrical current to the inverter 30 and the U-phase, V-phase, and W-phase windings 13U, 13V, and 13W to bring a q-axis current to zero. Such voltage step-up task will also be described below with reference to FIG. 5.

The controller 40 includes the command determiner 70. The command determiner 70 works to bring the value of one of the d-axis command current Id* and the q-axis command current Iq* defined in a two-phase rotating coordinate system (also called a d-q coordinate system), i.e., the q-axis command current Iq* in this embodiment to zero. Specifically, the command determiner 70 obtains and analyzes the pilot signal CP inputted through the low-voltage charging inlet to determine whether the connecting plug of the low-voltage charger 51 has been connected to the low-voltage charging inlet. When determining that the connection between the connecting plug of the low-voltage charger 51 and the low-voltage charging inlet is achieved, the command determiner 70 sets the value of the q-axis command current Iq* to zero.

The command determiner 70 may alternatively work to variably determine the d-axis command current Id* as a function of the value of the pilot signal CP inputted through the low-voltage charging inlet. For instance, the command determiner 70 may obtain a current rating of the low-voltage charger 51 using the value of the pilot signal CP. The command determiner 70 may set the d-axis command current Id* to a first value when the current rating of the low-voltage charger 51 is higher or to a second value smaller than the first value when the current rating of the low-voltage charger 51 is lower. This increases the electrical power supplied to the storage battery 20 as a function of the current rating of the low-voltage charger 51 in the voltage step-up task.

The controller 40 also includes the three-phase converter 71. The d-axis command current Id* and the q-axis command current Iq* are inputted to the three-phase converter 71. The three-phase converter 71 works to convert the d-axis command current Id* and the q-axis command current Iq* using the electrical angle θₑ into the U-phase, V-phase, and W-phase command currents I_{uvw}* in a three-phase fixed coordinate system. The electrical angle de may be given by a value measured by the angular position sensor 42.

The controller 40 also includes the deviation calculator 72. The U-phase, V-phase, and W-phase command currents I_{uvw}* and the U-phase, V-phase, and W-phase currents I_{uvw} are inputted to the deviation calculator 72. The deviation calculator 72 calculates a U-phase current deviation by subtracting the U-phase current from the U-phase command current. The deviation calculator 72 also calculates a V-phase current deviation by subtracting the V-phase current from the V-phase command current. The deviation calculator 72 also calculates a W-phase current deviation by subtracting the W-phase current from the W-phase command current. Each of the U-phase, V-phase, and W-phase currents I_{uvw} may be given by a value measured by the phase current sensor 41.

The controller 40 also includes the feedback controller 73. The U-phase, V-phase, and W-phase current deviations are inputted to the feedback controller 73. The feedback controller 73 calculates the U-phase, V-phase, and W-phase command voltages V_{uvw} using the U-phase, V-phase, and W-phase current deviations as feedback parameters used to feed the U-phase, V-phase, and W-phase currents I_{uvw} back to the U-phase, V-phase, and W-phase command currents I_{uvw}* in a feedback mode, such as a proportional-integral control mode.

The controller 40 also includes the modulator 74. The U-phase, V-phase, and W-phase command voltages V_{uvw} are inputted to the modulator 74. The modulator 74 compares each of the U-phase, V-phase, and W-phase command voltages V_{uvw} in level with a carrier signal to create the control signals for the upper and lower arm switches SUH to SWL and QU to QW of the inverter 30. The carrier signal may be in the form of a triangular wave. The upper and lower arm switches SUH to SWL and QU to QW are turned on or off in response to the control signals to perform the voltage step-up task, thereby causing a subset of the U-phase, the V-phase, and the W-phase to be selected as the specified phase. A corresponding one(s) of the clamp switches QU, QV, and QW which belongs to the subset is or are turned off, while the corresponding upper and lower arm switches are alternately turned on. The upper and lower arm switches of the phase(s) other than the specified phase are turned off, while the corresponding clamp switch(es) is turned on.

In this embodiment, the performing of the voltage step-up task shown in FIG. 5 sets the specified phase. The specified phase is not always unchanged, but may be altered during the performing of the voltage step-up task. For instance, the control signals may be produced to set the U-phase as the specified phase in a half of each switching cycle of the voltage step-up task and also set the U-phase and the V-phase as being included in the specified phase in the remainder of the switching cycle. The reason why the specified phase is altered during the performing of the voltage step-up task is because when the control signals are produced to select the specified phase to be the U-phase, the V-phase, the W-phase, a combination of the U- and W-phases, a combination of the V- and W-phases, or a combination of the U- and W-phases as a function of the angular position of the rotor 11, it may lead to a risk that the q-axis current may not be zero.

The above-described embodiment offers the following beneficial advantages.

The neutral point O and the positive terminal 51a of the low-voltage charger 51 are, as described above, connected together through the neutral point connector 62. The negative terminal of the storage battery 20 and the negative terminal 51b of the low-voltage charger 51 are also connected together through the negative connector 61. This achieves electrical connection of the storage battery 20 and the low-voltage charger 51 through the neutral point O. The voltage step-up task is performed in the condition where the storage battery 20 and the low-voltage charger 51 are electrically connected together through the negative connector 61 and the neutral point connector 62. In other words, the voltage step-up task is performed using the U-phase, V-phase, and W-phase windings 13U, 13V, and 13W of the rotating electrical machine 10 and the inverter 30. This eliminates the need for mounting an additional electrical circuit in the electrical power converter only to raise the charging voltage at the low-voltage charger 51 and facilitates the elevation of the charging voltage required at the low-voltage charger 51 using the inverter 30 and the rotating electrical machine 10 to ensure the stability in electrically charging the storage battery 20. This enables the size of the electrical power converter to be reduced.

The voltage step-up task is enabled to be performed using the phase windings 13U, 13V, and 13W of the rotating electrical machine 10 and the inverter 30 without having to modify the structure of the rotating electrical machine 10. This enables the electrical power converter to have a simplified structure as compared with the comparative example where the neutral point of the star-connected phase windings is connected to the low-voltage charger, thereby eliminating the need for increasing the production cost of the electrical power converter.

When it is determined that the positive terminal 51a of the low-voltage charger 51 and the neutral point connector 62 are electrically connected together, and the negative terminal 51b of the low-voltage charger 51 and the negative connector 61 are also electrically connected together, the controller 40 sets the q-axis command current Iq* to zero. This eliminates a risk that the rotor 11 of the rotating electrical machine 10 may be unintentionally rotated during the execution of the voltage step-up task.

If a mechanism which connects the high-voltage charger 50 or the low-voltage charger 51 with the inverter 30 is installed in the electrical power converter, it may lead to an increase in size of the electrical power converter. The structure of the electrical power converter in this embodiment is, however, capable of connecting the positive terminal 50a of the high-voltage charger 50 to the positive terminal of the storage battery 20 using the positive connector 60 and also connecting the negative terminal 50b of the high-voltage charger 50 to the negative terminal of the storage battery 20 using the negative connector 61 or connecting the positive terminal 51a of the low-voltage charger 51 to the neutral point O using the neutral point connector 62, and also connecting the negative terminal 51b of the low-voltage charger 51 to the negative terminal of the storage battery 20 using the negative connector 61. Consequently, the mechanism which electrically connects the negative terminal 50b of the high-voltage charger 50 to the inverter 30 is also used to electrically connect the negative terminal 51b of the low-voltage charger 51 to the inverter 30. This eliminates the need for an additional mechanism to electrically connect the negative terminal 50b of the high-voltage charger 50 or the negative terminal 51b of the low-voltage charger 51 to the inverter 30.

### Second Embodiment

The second embodiment will be described below in terms of differences between itself and the first embodiment with reference to the drawings. The second embodiment is different in structure of the inverter from the first embodiment.

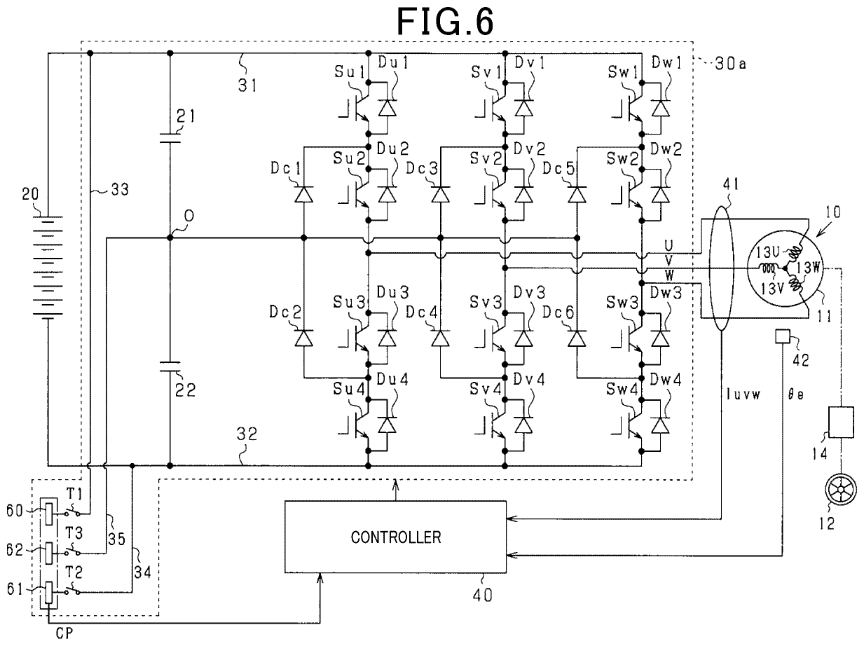

The motor control system in this embodiment, as illustrated in FIG. 6, includes the inverter 30a. The inverter 30a is implemented by a neutral point clamped three-level inverter. The inverter 30a includes the first to fourth U-phase switches Su1 to Su4, the first to fourth V-phase switches Sv1 to Sv4, the first to fourth W-phase switches Sw1 to Sw4, and the first to sixth clamp diodes Dc1 to Dc6. Each of the 20) switches Su1 to Su4, Sv1 to Sv4, and Sw1 to Sw4 is made of a voltage-controlled semiconductor switching device, such as an IGBT. Each of the switches Su1 to Su4, Sv1 to Sv4, and Sw1 to Sw4 has a corrector on a high-potential side and an emitter on a low-potential side. In FIG. 6 the same reference numbers as employed in FIG. 1 refer to the same parts, and explanation thereof in detail will be omitted here.

The first to fourth U-phase switches Su1 to Su4 are electrically connected in series with each other with each emitter connected to the adjacent corrector. The corrector of the first U-phase switch Su1 is connected to the positive terminal of the storage battery 20 through the positive bus bar 31. The emitter of the fourth U-phase switch Su4 is connected to the negative terminal of the storage battery 20 through the negative bus bar 32. A U-phase input terminal of the rotating electrical machine 10 is connected to a joint of the second U-phase switch Su2 and the third U-phase switch Su3. A joint of the first U-phase switch Su1 and the second U-phase switch Su2 is connected to the cathode of the first clamp diode Dc1. The anode of the first clamp diode Dc1 is connected to the cathode of the second clamp diode Dc2. The anode of the second clamp diode Dc2 is connected to a joint of the third U-phase switch Su3 and the fourth U-phase switch Su4. The freewheel diodes Du1, Du2, Du3, and Du4 are electrically connected in inverse-parallel to the U-phase switches Su1, Su2, Su3, and Su4, respectively.

The first to fourth V-phase switches Sv1 to Sv4 are electrically connected in series with each other with each emitter connected to the adjacent corrector. The corrector of the first V-phase switch Sv1 is connected to the positive terminal of the storage battery 20 through the positive bus bar 31. The emitter of the fourth V-phase switch Sv4 is connected to the negative terminal of the storage battery 20 through the negative bus bar 32. A V-phase input terminal of the rotating electrical machine 10 is connected to a joint of the second V-phase switch Sv2 and the third V-phase switch Sv3. A joint of the first V-phase switch Sv1 and the second V-phase switch Sv2 is connected to the cathode of the third clamp diode Dc3. The anode of the third clamp diode Dc3 is connected to the cathode of the fourth clamp diode Dc4. The anode of the fourth clamp diode Dc4 is connected to a joint of the third V-phase switch Sv3 and the fourth V-phase switch Sv4. The freewheel diodes Dv1, Dv2, Dv3, and Dv4 are electrically connected in inverse-parallel to the V-phase switches Sv1, Sv2, Sv3, and Sv4, respectively.

The first to fourth W-phase switches Sw1 to Sw4 are electrically connected in series with each other with each emitter connected to the adjacent corrector. The corrector of the first W-phase switch Sw1 is connected to the positive terminal of the storage battery 20 through the positive bus bar 31. The emitter of the fourth W-phase switch Sw4 is connected to the negative terminal of the storage battery 20 through the negative bus bar 32. A joint of the second W-phase switch Sw2 and the third W-phase switch Sw3 is connected to a W-phase input terminal of the rotating electrical machine 10. A joint of the first W-phase switch Sw1 and the second W-phase switch Sw2 is connected to the cathode of the fifth clamp diode Dc5. The anode of the fifth clamp diode Dc5 is connected to the cathode of the sixth clamp diode Dc6. The anode of the sixth clamp diode Dc6 is connected to a joint of the third W-phase switch Sw3 and the fourth W-phase switch Sw4. The freewheel diodes Dw1, Dw2, Dw3, and Dw4 are electrically connected in inverse-parallel to the W-phase switches Sw1, Sw2, Sw3, and Sw4, respectively.

Joints between the first clamp diode Dc1 and the second clamp diode Dc2, between the third clamp diode Dc3 and the fourth clamp diode Dc4, and between the fifth clamp diode Dc5 and the sixth clamp diode Dc6 are connected to the neutral point O.

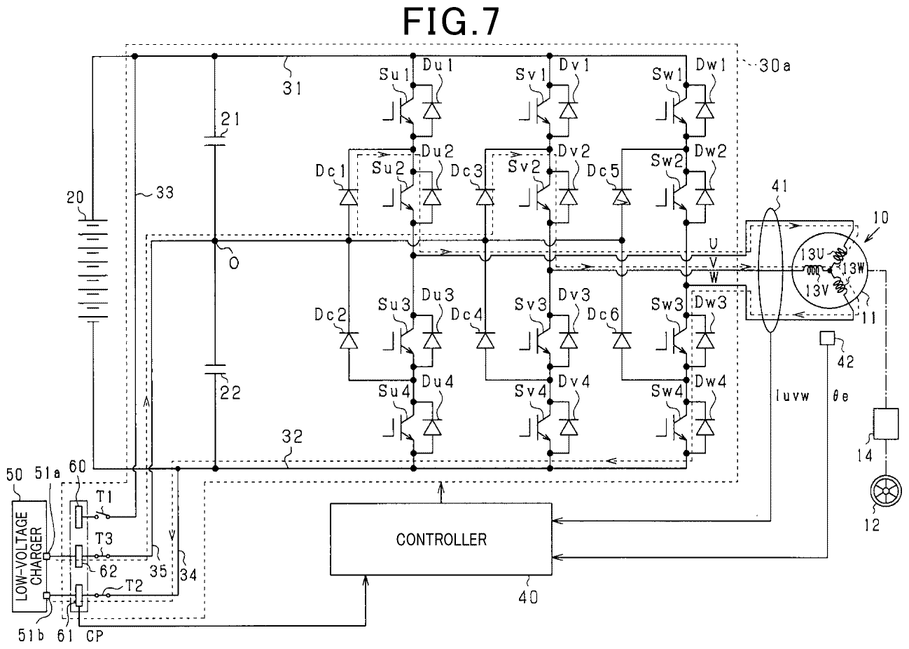

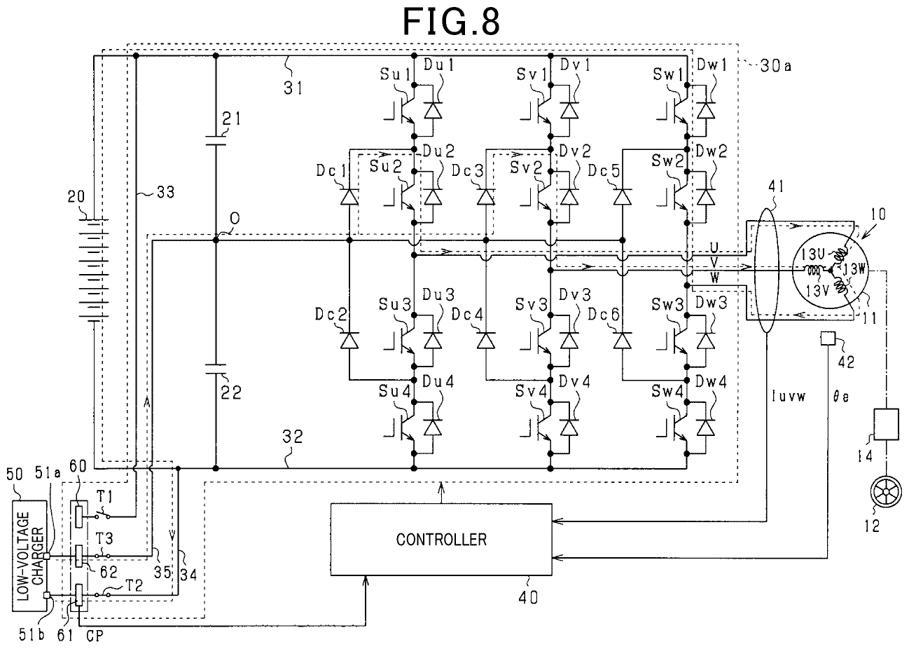

When the inverter 30 is electrically connected to the low-voltage charger 51 through the negative connector 61 and the neutral point connector 62, the controller 40 performs the voltage step-up task. The voltage step-up task in this embodiment will be described below in detail. When starting the voltage step-up task, the controller 40 alternately turns on a first switch and a second switch for the specified phase (i.e., one or some of the U-phase, the V-phase, and the W-phase) and also alternately turns on a third switch and a fourth switch for the specified phase. The first to fourth switches will be described later in detail. The specified phase will also be referred to below as a first phase, while one or some of the U-phase, the V-phase, and the W-phase other than the specified phase will also be referred to below as a second phase. The controller 40 also turns off a first switch, a third switch, and a fourth switch for the second phase and turns on a second switch for the second phase. FIGS. 7 and 8 illustrate electrical current flow paths in the voltage step-up task when the specified phase (i.e., the first phase) is the W-phase. The controller 40 may alternatively be designed to turn off only one of the third and fourth switches for the second phase in the voltage step-up task.

When the W-phase is selected as the specified phase in the voltage step-up task, the controller 40 turns off the first, third, and fourth U-phase and V-phase switches Su1, Sv1, Su3, Sv3, Su4, and Sv4 and turns on the second U-phase and V-phase switches Su2 and Sv2. The controller 40 also alternately turns on the first and second W-phase switches Sw1 and Sw2 and the third and fourth W-phase switches Sw3 and Sw4.

FIG. 7 demonstrates electrical current flow paths when the first and second W-phase switches Sw1 and Sw2 are turned off, and the third and fourth W-phase switches Sw3 and Sw4 are turned on. This creates a closed circuit including the low-voltage charger 51, the neutral point connector 62, the neutral point switch T3, the first and third clamp diodes Dc1 and Dc3, the second U-phase and V-phase switches Su2 and Sv2, the phase windings 13U, 13V, and 13W, the third and fourth W-phase switches Sw3 and Sw4, the negative bus bar 20) 32, the negative switch T2, and the negative connector 61. This causes magnetic energy to be accumulated in the phase windings 13U, 13V, and 13W.

FIG. 8 demonstrates electrical current flow paths when the first and second W-phase switches Sw1 and Sw2 are turned on, and the third and fourth W-phase switches Sw3 and Sw4 are turned off. This creates a closed circuit including the low-voltage charger 51, the neutral point connector 62, the neutral point switch T3, the first and third clamp diodes Dc1 and Dc3, the second U- and V-phase switches Su2 and Sv2, the phase windings 13U, 13V, and 13W, the first and second W-phase switches Sw1 and Sw2, the positive bus bar 31, the storage battery 20, the negative switch T2, and the negative connector 61. This elevates the charging voltage developed at the low-voltage charger 51 and delivers it to the storage battery 20.

The specified phase may be other than the W-phase. When the U-phase is selected as the specified phase, the controller 40 turns off the first, third, and fourth V-phase and W-phase switches Sv1, Sw1, Sv3, Sw3, Sv4, and Sw4, and turns on the second V-phase and W-phase switches Sv2 and Sw2. The controller 40 also alternately turns on the first and second U-phase switches Su1 and Su2, the third and fourth U-phase switches Su3 and Su4. When the V-phase is selected as the specified phase, the controller 40 turns off the first, third, and fourth U-phase and W-phase switches Su1, Sw1, Su3, Sw3, Su4, and Sw4 and turns on the second U-phase and W-phase switches Su2 and Sw2. The controller 40 also alternately turns on the first and second V-phase switches Sv1 and Sv2 and the third and fourth V-phase switches Sv3 and Sv4.

When the U-phase and the V-phase are selected as the specified phase, the controller 40 turns off the first, third, and fourth U-phase and V-phase switches Sw1, Sw3, and Sw4 and turns on the second W-phase switch Sw2. The controller 40 also alternately turns on the first and second U-phase and V-phase switches Su1, Sv1, Su2, and Sv2 and the third and fourth U-phase and V-phase switches Su3, Sv3, Su4, and Sv4. When the V-phase and W-phase are selected as the specified phase, the controller 40 turns off the first, third, and fourth U-phase switches Su1, Su3, and Su4 and turns on the second U-phase switch Su2. The controller 40 also alternately turns on the first and second V-phase and W-phase switches Sv1, Sw1, Sv2, and Sw2 and the third and fourth V-phase and W-phase switches Sv3, Sw3, Sv4, and Sw4. When the U-phase and the W-phase are selected as the specified phase, the controller 40 turns off the first, third, and fourth V-phase switches Sv1, Sv3, and Sv4 and turns on the second V-phase switch Sv2. The controller 40 also alternately turns on the first and second U-phase and W-phase switches Su1, Sw1, Su2, and Sw2 and the third and fourth U-phase and W-phases switches Su3, Sw3, Su4, and Sw4.

The controller 40, like in the first embodiment, may work to control flows of current through the inverter 30a and the 20) phase windings 13U, 13V, and 13W to bring the value of the q-axis current to zero.

### Other Embodiments

The above embodiments may be modified in the following ways.

The neutral point conducting wire 35 may alternatively be connected to an electrical load without being connected to the neutral point connector 62. The electrical load is operated on electrical power supplied from the storage battery 20. The electrical load is, for example, an electrical compressor or a DC-to-DC converter. The electrical compressor is used for air conditioning in a passenger compartment of the vehicle and actuated to circulate a cooling medium in a refrigerating cycle. The DC-to-DC converter is actuated to step-down an input voltage and supply it to the electrical compressor. The electrical load will also be referred to as an electrical device in this disclosure.

The electrical load may be being operated during actuation of the rotating electrical machine 10. This leads to a risk that a degree of voltage which is higher than a withstand voltage of the electric load may be applied to the electric load. In order to eliminate damage to the electrical load which is caused by such a risk, an additional circuit may be provided to step-down the voltage applied to the electrical load, however, it may result in an increase in size of the electrical power converter. The increasing of the withstand voltage of the electrical load may be preferable, however, it may result in an increase in total production cost of the motor control system.

In order to alleviate the above drawback, the electrical power converter in this embodiment is, as described above, designed to have the electrical load and the neutral point O connected together using the neutral point conducting wire 35. Specifically, the electrical load is connected to the second end of the second capacitor 22 through the negative conductor 34, so that the electrical load is connected in parallel to the second capacitor 22. When it is required to actuate the rotating electrical machine 10, the controller 40 turns on or off the switches SUH to SWL and QU to QW with the electrical load and the second capacitor 22 connected parallel to each other.

The controller 40, as described above, turns on or off the upper and lower arm switches SUH to SWL and the clamp switches QU to QW with the electrical load electrically connected to the second capacitor 22 in parallel to each other, thereby causing an output voltage of the second capacitor 22 to be applied to the electrical load. This results in a decrease in level of voltage applied to the electrical load as compared with then the electrical load is connected in parallel to the storage battery 20. This eliminates the need for an additional circuit to step-down the voltage applied to the electrical load or need for enhancing the withstand voltage of the electrical load.

The electrical load may alternatively be connected to the first end of the first capacitor 21 through the positive conductor 33 without being connected to the second end of the second capacitor 22 through the negative conductor 34. In this case, the electrical load is connected in parallel to the first capacitor 21.

The electrical power converter in this embodiment may be designed not to have the positive conductor 33, the positive connector 60, and the positive switch T1. In other words, the motor control system is not capable of being charged by the high-voltage charger 50.

In the voltage step-up task to create a flow of electrical current through the inverter 30 and the phase windings 13U, 13V, and 13W, the controller 40 may work to bring the q-axis current to a value selected around zero. For instance, the controller 40 may determine the q-axis command current Iq* to be a value which holds the rotor 11 of the rotating electrical machine 10 from rotating during execution of the voltage step-up task. Alternatively, the controller 40 may determine the q-axis command current Iq* to be a value around zero and also perform a torque reduction task to reduce the degree of torque transmitted from the power transmission device 14 to the drive heels 12. The torque reduction task may be achieved by decreasing the degree with which torque delivered from an output shaft of a clutch to the axle of the vehicle and/or decreasing a gear ratio of the power transmission device 14. This keeps the rotor 11 of the rotating electrical machine 10 substantially at the rest state when the value of the q-axis current is set to a value around zero in the voltage step-up task.

The U-phase, V-phase, and W-phase clamp switches may alternatively be connected together at the drains thereof instead of the sources. In this case, one of sources of the switching devices constituting the U-phase clamp switch QU is connected to a joint of the U-phase upper arm switch SUH and the U-phase lower arm switch SUL, while the other source is connected to the neutral point O.

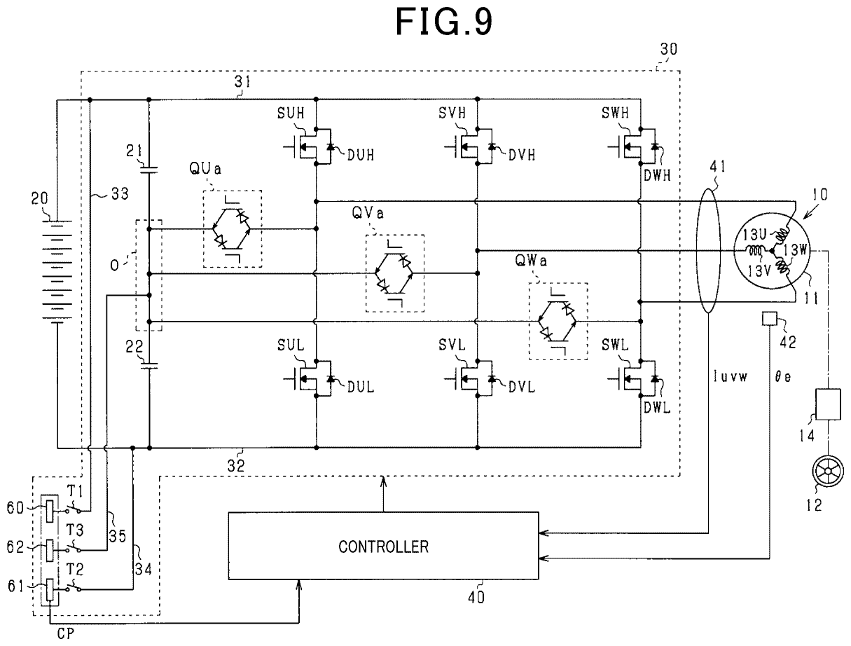

Each of the U-phase, V-phase, and W-phase clamp switches QU, QV, and QW may be designed not to have two switching devices connected in series with each other, but may alternatively be, as illustrated in FIG. 9, made in the form of a clamp switch QUa, QVa, or QWa including a pair of reverse blocking IGBTs (RB-IGBTs). A joint of the U-phase upper arm switch SUH and the U-phase lower arm switch SUL is connected to the neutral point O through the U-phase clamp switch QUa made of the RB-IGBTs connected in reverse parallel to each other. A joint of the V-phase upper arm switch SVH and the V-phase lower arm switch SVL is connected to the neutral point O through the V-phase clamp switch QVa made of the RB-IGBTs connected in reverse parallel to each other. A joint of the W-phase upper arm switch SWH and the W-phase lower arm switch SWL is connected to the neutral point O through the W-phase clamp switch QWa made of the RB-IGBTs connected in reverse parallel to each other.

The semiconductor switches of the inverter 30 are not limited to n-channel MOSFETs, but may be implemented by IGBTs. Conversely, the semiconductor switches of the inverter 30a in the second embodiment may alternatively be made of n-channel MOSFETs.

The rotating electrical machine 10, as described above, has the U-phase, V-phase, and W-phase windings 13U, 13V, and 13W which are star-connected together, but may alternatively be designed to have the U-phase, V-phase, and W-phase windings 13U, 13V, and 13W electrically connected in the form of delta connection. The inverter 30 may also be designed for two phases or four or more phases.

The electrical power converter in the above embodiments may be mounted in moving objects, such as airplanes or ships, other than automotive vehicles. In the case of airplanes, the rotating electrical machine 10 is used as a flying power source. In the case of ships, the rotating electrical machine 10 is used as a propulsion power source. The electrical power converter may be installed stationary instead of installation in moving objects.

The above embodiments realize the following unique structures.

### First Structure

An electrical power converter for use with a system including a storage battery and an electrical device which is electrically connectable with the storage battery. The electrical power converter comprises (a) a three-level inverter which is electrically connected to the storage battery; (b) a rotating electrical machine which includes multi-phase windings electrically connected to the three-level inverter; (c) a connector; and (d) a controller. The electrical device is disposed outside the electrical power converter and implemented by a charger working to charge the storage battery. The three-level inverter includes a first electrical storage device, a second electrical storage device, and switches. The first electrical storage device and the second electrical storage device are connected in series with each other. The switches work to connect the windings with a positive side of the first electrical storage device, a neutral point between a negative side of the first electrical storage device and a positive side of the second electrical storage device, or a negative side of the second electrical storage device. The switches include upper arm switches and lower arm switches for a plurality of phases of the rotating electrical machine. The upper and lower arm switches being connected in series with each other. The switches of the three-level inverter also include clamp switches each for one of the phases of the rotating electrical machine. Each of the clamp switches establishes or blocks a flow of electrical current between a corresponding one of the windings and the neutral point. The positive side of the first electrical storage device is connected to a positive terminal of storage battery. The negative side of the second electrical storage device is connected to a negative terminal of the storage battery. The connector works to achieve electrical connection of the electrical device with the three-level inverter and also achieve electrical connection of the electrical device with the storage battery through the neutral point. The controller works to control switching operations of the switches to achieve transmission of electrical power between the electrical device and the storage battery with the three-level inverter and the electrical device connected together through the connector. The connector includes a neutral point connector and a negative connector. The neutral point connector connects a positive terminal of the charger to the neutral point. The negative connector connects a negative terminal of the charger to the negative side of the second electrical storage device. The controller works to start a voltage step-up task to perform the switching operations with the charger connected to the three-level inverter through the neutral point connector and the negative connector to create flows of electrical current through the three-level inverter and the windings, thereby stepping-up charging voltage developed at the charger and delivering the stepped-up charging voltage to the storage battery. In the voltage step-up task, the controller turns off a first clamp switch that is at least one of the clamp switches for a specified phase that is at least one of the phases of the multi-phase rotating electrical machine and alternately turns on first upper and lower arm switches that are the upper and lower arm switches for the specified phase. The controller also turns off second upper and lower arm switches that are the upper and lower arm switches other than the first upper and lower arm switches and turns on a second clamp switch that is at least one of the clamp switches other than the first clamp switch.

### Second Structure

An electrical power converter for use with a system including a storage battery and an electrical device which is electrically connectable with the storage battery. The electrical power converter comprises: (a) a three-level inverter which is electrically connected to the storage battery; (b) a rotating electrical machine which includes windings electrically connected to the three-level inverter; (c) a connector; and (d) a controller. The electrical device is disposed outside the electrical power converter and implemented by a low-voltage charger working to charge the storage battery. The low-voltage charger has a charging voltage lower than a voltage rating of the storage battery. The three-level inverter includes a first electrical storage device, a second electrical storage device, and switches. The first electrical storage device and the second electrical storage device are connected in series with each other. The switches work to connect the windings with a positive side of the first electrical storage device, a neutral point between a negative side of the first electrical storage device and a positive side of the second electrical storage device, or a negative side of the second electrical storage device. The positive side of the first electrical storage device is connected to a positive terminal of storage battery. The negative side of the second electrical storage device is connected to a negative terminal of the storage battery. The connector works to achieve electrical connection of the electrical device with the three-level inverter and also achieve electrical connection of the electrical device with the storage battery through the neutral point. The controller works to control switching operations of the switches to achieve transmission of electrical power between the electrical device and the storage battery with the three-level inverter and the electrical device connected together through the connector. The connector includes a neutral point connector, a negative connector, and a positive connector. The neutral point connector connects a positive terminal of the low-voltage charger to the neutral point. The negative connector connects a negative terminal of the low-voltage charger to the negative side of the second electrical storage device. The positive connector connects a positive side of a high-voltage charger whose charging voltage is lower than that of the low-voltage charger with a positive side of the first electrical storage device. The controller works to start a voltage step-up task to perform the switching operations with the low-voltage charger connected to the three-level inverter through the neutral point connector and the negative connector to create flows of electrical current through the three-level inverter and the windings, thereby stepping-up charging voltage developed at the low-voltage charger and delivering the stepped-up charging voltage to the storage battery.

### Third Structure

The electrical power converter as set forth in the second structure, wherein the rotating electrical machine is designed as a multi-phase rotating electrical machine. The switches of the three-level inverter include upper arm switches (SUH to SWH) and lower arm switches (SUL to SWL) for a plurality of phases of the rotating electrical machine. The upper and lower arm switches are connected in series with each other. The switches of the three-level inverter also include clamp switches (QU to QW) each for one of the phases of the multi-phase rotating electrical machine. Each of the clamp switches establishes or blocks a flow of electrical current between a corresponding one of the windings and the neutral point. In the voltage step-up task, the controller turns off a first clamp switch that is at least one of the clamp switches for a specified phase that is at least one of the phases of the multi-phase rotating electrical machine and alternately turns on first upper and lower arm switches that are the upper and lower arm switches for the specified phase. The controller also turns off second upper and lower arm switches that are the upper and lower arm switches other than the first upper and lower arm switches and turns on a second clamp switch that is at least one of the clamp switches other than the first clamp switch.

### Fourth Structure

The electrical power converter as set forth in the second structure, wherein the rotating electrical machine is designed as a multi-phase rotating electrical machine. The switches of the three-level inverter include first switches (Su1 to Sw1) connected in series with each other, each for one of a plurality of phases of the multi-phase rotating electrical machine, second switches (Su2 to Sw2) connected in series with each other, each for one of the phases, third switches (Su3 to Sw3) connected in series with each other, each for one of the phase, and fourth switches (Su4 to Sw4) connected in series with each other, each for one of the phases. The three-level inverter includes first clamp diodes (Dc1, Dc3, Dc5), one for each of the phases of the multi-phase rotating electrical machine, and second clamp diodes (Dc2, Dc4, Dc6), one for each of the phases. The first switches have high-potential terminals connected to the positive terminal of the storage battery. The fourth switches have low-potential terminals connected to the negative terminal of the storage battery. Joints of the second switches to the third switches are connected to the windings. Joints of the first switches to the second switches are connected to cathodes of the first clamp diodes. The first clamp didoes have anodes connected to cathodes of the second clamp diodes. The second clamp diodes have anodes connected to joints of the third switches and the fourth switches. Joints of the first clamp diodes to the second clamp diodes are connected to the neutral point. In the voltage step-up task, the controller alternately turns on the first and second switches for a specified phase that is at least one of the phases of the multi-phase rotating electrical machine and also turns on the third and fourth switches for the specified phase. Additionally, in the voltage step-up task, the controller also turns off at least one of the first switches and turns on at least one of the second switches for at least one of the phases other than the specified phase. The controller also turns off at least one of the third switches and/or at least one of the fourth switches for at least one of the phases other than the specified phase.

### Fifth Structure

The electrical power converter as set forth in any one of the first to fourth structures, wherein in the voltage step-up 20) task, the controller works to create flows of electrical current through the three-level inverter and the windings to bring a q-axis current to zero or a value around zero.

### Sixth Structure

The electrical power converter as set forth in the fifth structure, wherein the system is a vehicle-mounted system installed in a vehicle. The rotating electrical machine has a rotor (11) which is capable of transmitting power between itself and a drive wheel (12) of the vehicle.

### Seventh Structure

The electrical power converter as set forth in the first structure, wherein the charger is a low-voltage charger (51) whose charging voltage is lower than a voltage rating of the storage battery. The connector includes the neutral point connector, the negative connector, and a positive connector (60) which connects a positive side of a high-voltage charger (50) whose charging voltage is lower than that of the low-voltage charger with a positive side of the first electrical storage device.

This disclosure is not limited to the above embodiments, but may be realized by various embodiments without departing from the purpose of the disclosure. This disclosure includes all possible combinations of the features of the above embodiments, features similar to or equivalents of the parts of the above embodiments, or modifications of the above embodiments. The structures in this disclosure may include only one or some of the features discussed in the above embodiments unless otherwise inconsistent with the aspects of this disclosure.

What is claimed is:

1. An electrical power converter for use with a system including a storage battery and an electrical device which is electrically connectable with the storage battery, comprising:
a three-level inverter which is electrically connected to the storage battery;
a rotating electrical machine which includes multi-phase windings electrically connected to the three-level inverter;
a connector; and
a controller, wherein
the electrical device is disposed outside the electrical power converter and implemented by a charger working to charge the storage battery,
the three-level inverter includes a first electrical storage device, a second electrical storage device, and switches, the first electrical storage device and the second electrical storage device being connected in series with each other, the switches working to connect the windings with a positive side of the first electrical storage device, a neutral point between a negative side of the first electrical storage device and a positive side of the second electrical storage device, or a negative side of the second electrical storage device,
the switches include upper arm switches and lower arm switches for a plurality of phases of the rotating electrical machine, the upper and lower arm switches being connected in series with each other,
the switches of the three-level inverter also include clamp switches each for one of the phases of the rotating electrical machine, each of the clamp switches establishing or blocking a flow of electrical current between a corresponding one of the windings and the neutral point,
the positive side of the first electrical storage device is connected to a positive terminal of storage battery,
the negative side of the second electrical storage device is connected to a negative terminal of the storage battery,
the connector works to achieve electrical connection of the electrical device with the three-level inverter and also achieve electrical connection of the electrical device with the storage battery through the neutral point, and
the controller works to control switching operations of the switches to achieve transmission of electrical power between the electrical device and the storage battery with the three-level inverter and the electrical device connected together through the connector,
the connector includes a neutral point connector and a negative connector, the neutral point connector connecting a positive terminal of the charger to the neutral point, the negative connector connecting a negative terminal of the charger to the negative side of the second electrical storage device,
the controller works to start a voltage step-up task to perform the switching operations with the charger connected to the three-level inverter through the neutral point connector and the negative connector to create flows of electrical current through the three-level inverter and the windings, thereby stepping-up charging voltage developed at the charger and delivering the stepped-up charging voltage to the storage battery, and
in the voltage step-up task, the controller turns off a first clamp switch that is at least one of the clamp switches for a specified phase that is at least one of the phases of the multi-phase rotating electrical machine and alternately turns on first upper and lower arm switches that are the upper and lower arm switches for the specified phase, the controller also turning off second upper and lower arm switches that are the upper and lower arm switches other than the first upper and lower arm switches and turning on a second clamp switch that is at least one of the clamp switches other than the first clamp switch.

2. An electrical power converter for use with a system including a storage battery and an electrical device which is electrically connectable with the storage battery, comprising:
a three-level inverter which is electrically connected to the storage battery;
a rotating electrical machine which includes windings electrically connected to the three-level inverter;
a connector; and
a controller, wherein
the electrical device is disposed outside the electrical power converter and implemented by a low-voltage charger working to charge the storage battery, the low-voltage charger having a charging voltage lower than a voltage rating of the storage battery,
the three-level inverter includes a first electrical storage device, a second electrical storage device, and switches, the first electrical storage device and the second electrical storage device being connected in series with each other, the switches working to connect the windings with a positive side of the first electrical storage device, a neutral point between a negative side of the first electrical storage device and a positive side of the second electrical storage device, or a negative side of the second electrical storage device,
the positive side of the first electrical storage device is connected to a positive terminal of storage battery,
the negative side of the second electrical storage device is connected to a negative terminal of the storage battery,
the connector works to achieve electrical connection of the electrical device with the three-level inverter and also achieve electrical connection of the electrical device with the storage battery through the neutral point,
the controller works to control switching operations of the switches to achieve transmission of electrical power between the electrical device and the storage battery with the three-level inverter and the electrical device connected together through the connector,
the connector includes a neutral point connector, a negative connector, and a positive connector, the neutral point connector connecting a positive terminal of the low-voltage charger to the neutral point, the negative connector connecting a negative terminal of the low-voltage charger to the negative side of the second electrical storage device, the positive connector connecting a positive side of a high-voltage charger whose charging voltage is lower than that of the low-voltage charger with a positive side of the first electrical storage device,
the controller works to start a voltage step-up task to perform the switching operations with the low-voltage charger connected to the three-level inverter through the neutral point connector and the negative connector to create flows of electrical current through the three-level inverter and the windings, thereby stepping-up charging voltage developed at the low-voltage charger and delivering the stepped-up charging voltage to the storage battery.

3. The electrical power converter as set forth in claim 2, wherein the rotating electrical machine is designed as a multi-phase rotating electrical machine,
the switches of the three-level inverter include upper arm switches and lower arm switches for a plurality of phases of the rotating electrical machine, the upper and lower arm switches being connected in series with the upper arm switches,
the switches of the three-level inverter also include clamp switches each for one of the phases of the multi-phase rotating electrical machine, each of the clamp switches establishing or blocking a flow of electrical current between a corresponding one of the windings and the neutral point,
in the voltage step-up task, the controller turns off a first clamp switch that is at least one of the clamp switches for a specified phase that is at least one of the phases of the multi-phase rotating electrical machine and alternately turns on first upper and lower arm switches that are the upper and lower arm switches for the specified phase, the controller also turning off second upper and lower arm switches that are the upper and lower arm switches other than the first upper and lower arm switches and turning on a second clamp switch that is at least one of the clamp switches other than the first clamp switch.

4. The electrical power converter as set forth in claim 2, wherein the rotating electrical machine is designed as a multi-phase rotating electrical machine,
the switches of the three-level inverter include first switches connected in series with each other, each for one of a plurality of phases of the multi-phase rotating electrical machine, second switches connected in series with each other, each for one of the phases, third switches connected in series with each other, each for one of the phase, and fourth switches connected in series with each other, each for one of the phases,
the three-level inverter includes first clamp diodes, one for each of the phases of the multi-phase rotating electrical machine, and second clamp diodes, one for each of the phases,
the first switches have high-potential terminals connected to the positive terminal of the storage battery,
the fourth switches have low-potential terminals connected to the negative terminal of the storage battery,
joints of the second switches to the third switches are connected to the windings,
joints of the first switches to the second switches are connected to cathodes of the first clamp diodes,
the first clamp didoes have anodes connected to cathodes of the second clamp diodes,
the second clamp diodes have anodes connected to joints of the third switches and the fourth switches,
joints of the first clamp diodes to the second clamp diodes are connected to the neutral point,
in the voltage step-up task, the controller alternately turns on the first and second switches for a specified phase that is at least one of the phases of the multi-phase rotating electrical machine and also turns on the third and fourth switches for the specified phase,
in the voltage step-up task, the controller also turns off at least one of the first switches and turns on at least one of the second switches for at least one of the phases other than the specified phase, the controller also turning off at least one of the third switches and/or at least one of the fourth switches for at least one of the phases other than the specified phase.

5. The electrical power converter as set forth in claim 2, wherein in the voltage step-up task, the controller works to create flows of electrical current through the three-level inverter and the windings to bring a q-axis current to zero or a value around zero.

6. The electrical power converter as set forth in claim 5, wherein the system is a vehicle-mounted system installed in a vehicle, and
the rotating electrical machine has a rotor which is capable of transmitting power between itself and a drive wheel of the vehicle.

7. The electrical power converter as set forth in claim 1, wherein the charger is a low-voltage charger whose charging voltage is lower than a voltage rating of the storage battery,
the connector includes the neutral point connector, the negative connector, and a positive connector which connects a positive side of a high-voltage charger whose charging voltage is lower than that of the low-voltage charger with a positive side of the first electrical storage device.
